(19) United States
(12) Patent Application Publication
(10) Pub. No.: US 2021/0147044 A1
(43) Pub. Date: May 20, 2021

(54) COLOR LOCK-OUT SYSTEM

(71) Applicant: ITC Incorporated, Hudsonville, MI (US)

(72) Inventors: Brad Beers, Hudsonville, MI (US); Michael V. Camarota, Hudsonville, MI (US); Dirrick Ferrell, Hudsonville, MI (US)

(73) Assignee: ITC Incorporated, Hudsonville, MI (US)

(21) Appl. No.: 17/084,005

(22) Filed: Oct. 29, 2020

Related U.S. Application Data
(60) Provisional application No. 62/927,260, filed on Oct. 29, 2019.

(51) Int. Cl. B63B 45/04; H05B 45/20; H05B 47/115

(52) U.S. Cl. CPC B63B 45/04; H05B 47/115; H05B 45/20

(57) ABSTRACT

A light control system configured to lock-out the predetermined color spectrums corresponding to red, green, white and blue (or other jurisdictionally restricted colors). In some embodiments, when a specific trigger is detected, then the predetermined color spectrum is prohibited from being displayed (i.e. locked-out). If a trigger is detected, the user is only permitted to display colors outside of the predetermined locked-out color spectrum so as to prevent confusion by third party vessels.

### CROSS-REFERENCE TO RELATED APPLICATIONS

This application claims priority to U.S. Provisional Patent Application No. 62/927,260 filed on Oct. 29, 2019 and entitled COLOR LOCK-OUT SYSTEM which is hereby incorporated by reference.

### TECHNICAL FIELD

The present specification generally relates to a system to control lighting color and, more specifically, a system for preventing illumination predetermined spectrum colors in lighting in or on marine vehicles at predetermined times or locations.

### BACKGROUND

In accordance with U.S. Coast Guard regulations, recreational water vessels are required to display navigation lights between sunset and sunrise and during periods of restricted visibility (fog, rain, haze, etc.). Coast Guard minimum equipment requirements vary with the size of your boat, type of propulsion, whether operated at night or in periods of reduced visibility, and, in some cases, the body of water on which it is used.

By way of example, powerboats under 12 meters (39.4 feet) in length must have separate or combined red and green sidelights covering 112.5 degrees and visible for 1 nautical mile. The white masthead light must cover 225 degrees, be 1 meter above the sidelights and be visible for 2 nautical miles. The white stem light must cover 135 degrees and be visible for 2 nautical miles, or you can substitute one 360-degree all-around white light. For larger boats, the sidelights must be visible for 2 nautical miles and the masthead light for 3 nautical miles. Similar light displays are required for sailboats and powerboats over 12 meters where most vessels are required to display some combination of red, green and white light. It should be appreciated that the present system can be used on any marine vessel including, but not limited to, powerboats, pontoon boats, personal watercraft, sailboats . . . etc.

Further, blue lights are often used and/or required by law enforcement vessels. Additionally, certain jurisdictions may also prohibit the use of yellow. Additionally, other light spectrums identifying specific colors may be used in emergency vehicles or vessels in marine situations.

The red, green, white and blue lights in required navigation and as used by law-enforcement is commonly associated with a specific spectrum section of colors.

The U.S. Coast Guard has expressed concerned about the sale and availability of increased lighting within marine vehicles. Technical advances in marine lighting, such as the use of Light Emitting Diodes (LEDs), rope lighting, underwater lighting, and other various types of decorative lighting, may violate various navigation guidelines.

In view of these guidelines, boaters are increasingly concerned about installing decorative lighting on or in their boats in various places, including cabin lighting, underwater lighting, or lighting at waterline. Care must be taken that these lights are not mistaken for navigation, law enforcement or emergency vessel lights and/or do not impair the visibility or distinctive character of approved and properly placed navigation, law enforcement or emergency vessel lights. Such circumstances may represent a violation of various laws and regulations. It should be appreciated that international jurisdictions require the same or similar restrictions for navigation, law enforcement or emergency vessel lights.

Accordingly, a need exists for alternative lighting controls for marine vessels which enable users to comply with lighting guidelines.

### SUMMARY

A color lock-out light controller is generally presented. The light controller is configured to control lighting parameters for one or more LED lights on a marine vessel, and specifically to modify the spectrum of light emitted from the LEDs. The light input controller may be configured to receive one or more inputs. The inputs may be used to determine a trigger condition for limited the spectrum of light emitted from the LEDs. The light controller may be configured to lock out a predetermined spectrum of light when one or more of the trigger inputs are received.

In an embodiment, the one or more inputs includes an input to determine the speed or movement of the vessel to allow the light controller to lock out the predetermined spectrum of light when the vessel is in motion. The inputs may include a motion sensor to detect motion of the vessel, a flow sensor to detect the flow of water near the vessel, a GPS to detect movement of the vessel, an engine status input, and a light input indicating if a vessel navigation light is on. The light controller may be integrated with or in communication with a vehicle controller of the vessel

In an embodiment, the light controller is configured to trigger lockout of the predetermined spectrum of light based on a time of day. In another embodiment, the light controller is configured to receive a light sensor input, wherein the light sensor is configured to sense ambient light levels and lock out the predetermined spectrum of light based on ambient light levels reaching a predetermined threshold.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a vessel having the color lock-out system according to one or more embodiments shown and described herein;

FIG. 2 depicts a graphical representation of the green color restrictions graphed at corresponding points according to one or more embodiments shown and described herein;

FIG. 3 depicts a chart illustrating the U.S. Coast Guard color restrictions (red and yellow) according to one or more embodiments shown and described herein;

FIG. 4 depicts a graphical representation of the yellow and red color restrictions graphed at corresponding points according to one or more embodiments shown and described herein;

FIG. 5 depicts a schematically represented diagram of a vessel having a light control system having color lock-out according to one or more embodiments shown and described herein;

FIG. 6 illustrates a flow chart of the steps taken by the color-lock out system of the present specification according to one or more embodiments shown and described herein; and

### DETAILED DESCRIPTION

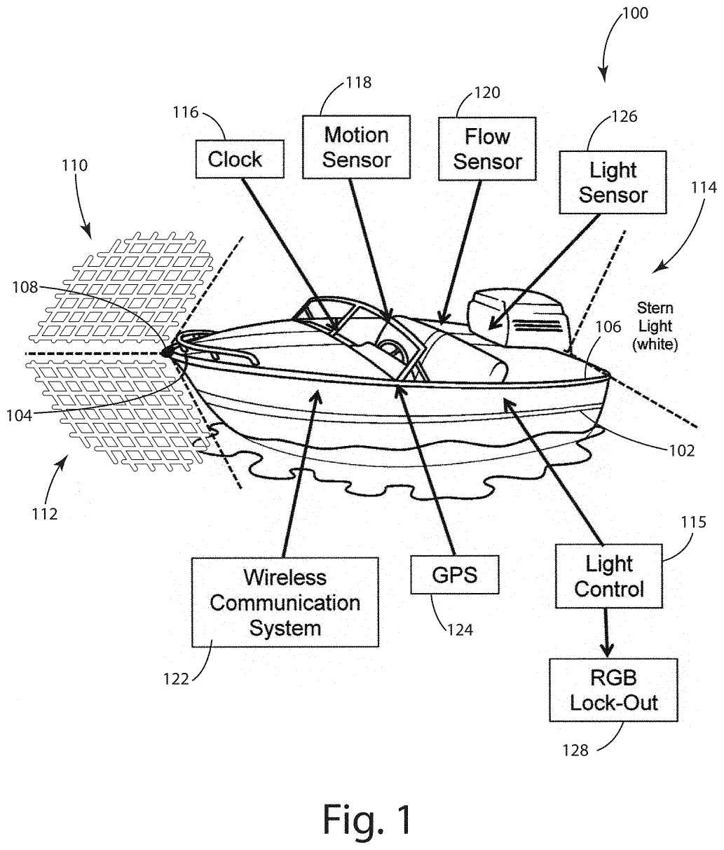

FIG. 1 generally depicts a vessel 102 having a light control system configured to lock-out illumination of predetermined color spectrums corresponding to red, green, white and/or blue (or other predetermined colors) when a specific trigger is detected. If a trigger is detected, the user is only permitted to display colors outside of the predetermined locked-out navigation, law enforcement or emergency vessel light color spectrums (i.e. red, green, white and/or blue).

By way of example, if the system 100 detects that the navigation lights are in an ON position, then the system will prevent the user from displaying (in cabin or otherwise) any lights falling in the predetermined locked-out navigation, law enforcement or emergency vessel light color spectrums, or in other predetermined light or color spectrums. Specifically, the lock-out feature may comprise locking out or preventing the lights from emitting light in any predetermined spectrum of light color, including the entire spectrum of light color (on/off) or in a limited spectrum of light, as described below and illustrated in the FIGS. In other embodiments, if the system 100 detects that the vessel is in motion (by GPS, motion sensors . . . etc.), then the system will prevent the user from displaying (in cabin or otherwise) any lights falling in the predetermined locked-out navigation, law enforcement or emergency vessel light color spectrums. Further details and variances are discussed herein. As used herein the term “in cabin” lighting may refer to any lighting on the vessel other than exterior lighting. However, it will be appreciated that both in cabin lighting and exterior lighting, or one or the other, may be locked out from displaying certain spectrums of light or color spectrums, as described below. Further, the system 100 may define or employ various zones of lighting that may be selectively locked out from various color spectrums based on a given trigger.

Referring now to FIG. 1, the system 100 generally comprises a marine vessel 102 having a bow 104 and a stern 106. The vessel 102 includes a bow light 108 configured to display the requisite red and green lighting to indicate port and starboard sides. The starboard lighting 110, in compliance with U.S. Coast Guard regulations, is green while the port side lighting 112 is red in accordance with U.S. Coast Guard regulations. The green light 110 and the red light 112 illuminates from the bow light 108. The bow light 108 is configured to shine the lights 110, 112 in the appropriate direction in accordance with U.S. Coast Guard regulations.

The vessel 102 includes the stern 106 having a stern light 114 (also referred to as navigation light 110). The stern light 114 emits a white light in a direction fanned out from the stern of the vessel 102.

The side lights 110, 112 (also referred to as navigation lights 110, 112) are required to shine from dead ahead to 112.5 degrees aft on either side. The stern light 114 shines aft and 67.5 degrees forward on each side thereby creating a full circle of light when the side lights and stern light are combined and viewed from above. Additionally, some vessels include all around lights which are typically white and viewable 360 degrees around the vessel. U.S. Coast Guard regulations may require mast headlights which are white and shine from 112.5 degrees on the port side through dead ahead to 112.5 degrees on the starboard side. U.S. Coast Guard regulations may provide for and require other specific light indicators using any combination of red, green, or white light. The following embodiments and description may therefore be applied to any U.S. Coast Guard regulated vessel and not just the vessel as illustrated in FIG. 1. The vessel 102 of FIG. 1 further includes a plurality of equipment variations utilized in the present system. The vessel 102 may optionally include a clock 116. The clock 116 may be configured to determine and monitor predetermined times for RGB lock-out (also referred to as color lock-out). In some embodiments, if the clock 116 determines that sunset is at a predetermined time whereby U.S. Coast Guard regulations require navigation lights 110, 112, 114, to be turned on at sunset, then color lock-out will be enacted at the time of sunset. Similarly, if the clock 116 determines a predetermined time for sunrise, color lock-out will be deactivated thereby allowing the user to modify cabin lighting colors to the full spectrum.

The vessel 102 may further include a motion sensor 118. The motion sensor 118 may be in communication with the light control system 115 thereby allowing the light control system 115 to enable the color lock-out only when the motion sensor 118 indicates movement of the vessel 102. If, for example, the motion sensor 118 does not detect movement of the vessel 102, it may be determined that the vessel 102 is docked or anchored, thus negating the requirement for illuminated navigation lights 110, 112, 114. The motion sensor 118 may further be in communication with a GPS system 124, in some embodiments, so as to confirm that the vessel is in fact docked or otherwise in a location not requiring use of the navigation lights 110, 112, 114.

In further embodiments, the vessel 102 may include a water or flow sensor 120. The flow sensor 120 is configured to determine if the vessel 102 is in motion by evaluating a flow rate or water movement detectable on the hull of the vessel 102. If the flow sensor 120 detects movement of the water surrounding the vessel 102 thereby indicating that the vessel 102 is in motion, then the color lock-out will be enabled. If the flow sensor 120 detects and determines that the vessel 102 is not in motion, then the color lock-out may be disabled. As with prior embodiments, the flow sensor 120 may be used in connection with the GPS 124 so as to properly determine and ensure that the vessel 102 is in fact docked or positioned in a place where navigation lights 110, 112, 114 are not required.

The vessel 102 may further include wireless communication means 122 whereby time and weather information are transmitted to the vessel 102. In this embodiment, the wireless communication system 122 may transmit weather, sunrise, sunset, local regulations, U.S. Coast Guard regulations, and/or any other information required to determine if navigation lights 110, 112, 114 are required at any particular time. By way of example, the wireless communication system 122 may transmit weather information to the vessel 102 indicating high fog conditions thereby necessitating the need to illuminate the navigation lights 110, 112, 114. In this situation, if the navigation lights 110, 112, 114 are illuminated, the color lock-out will be enabled based on information received from the wireless communication system 122. Similarly, the wireless communication system 122 may transmit sunrise and sunset information, which changes daily depending on location and time of year, to the vessel. In these situations, both the wireless communication system 122 is used to transmit information to the vessel 102, the navigation lights 110, 112, 114 may be automatically turned on and/or the color lock-out may be enabled or disabled depending on the information received.

The vessel 102 may further include the GPS system 124, such as previously mentioned. The GPS system 124 may be used in connection with other sensors, such as the motion sensor 118 or the flow sensor 120 or used solely by itself to determine if navigation lights 110, 112, 114 are necessary thus dictating the need to enable the color lock-out. If, for example, it is determined by the GPS 124 that the vessel 102 is not in motion and docked in a marina, then the navigation lights 110, 112, 114 may be automatically turned off and the color lock-out disabled. However, if the GPS 124 determines that the vessel 102 is in motion, then the navigation lights 110, 112, 114 will be illuminated at the color lock-out will be enabled thereby only allowing the user to display colors outside the U.S. Coast Guard restricted colors.

The vessel 102 may further include a light sensor 126. The light sensor 126 is configured to determine the light level exterior to the vessel 102 to determine if navigation lights 110, 112, 114 are required. The light sensor 126 is configured to detect ambient light. If the light sensor 126 determines a low light level due to time of day or inclement weather conditions, such as fog or haze, then the navigation lights 110, 112, 114 will be illuminated thereby enabling the color lock-out. In other embodiments, if the light sensor 126 detects low ambient light, then the color lock-out will be automatically illuminated without first turning on the navigation lights 110, 112, 114. Similarly, if the light sensor 126 determines that the ambient light is above a predetermined threshold, for example when sunrise is occurring, then the navigation lights 110, 112, 114 will be turned off and the color lock-out will be disabled thereby allowing the user to display the entire spectrum of in-cabin lighting.

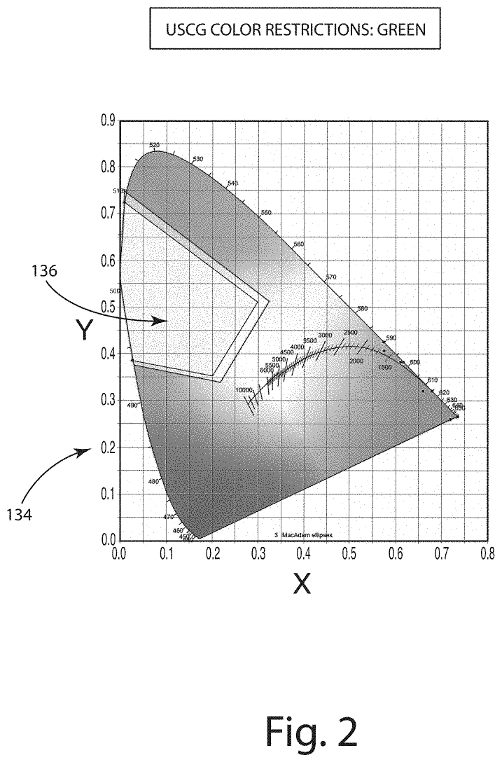

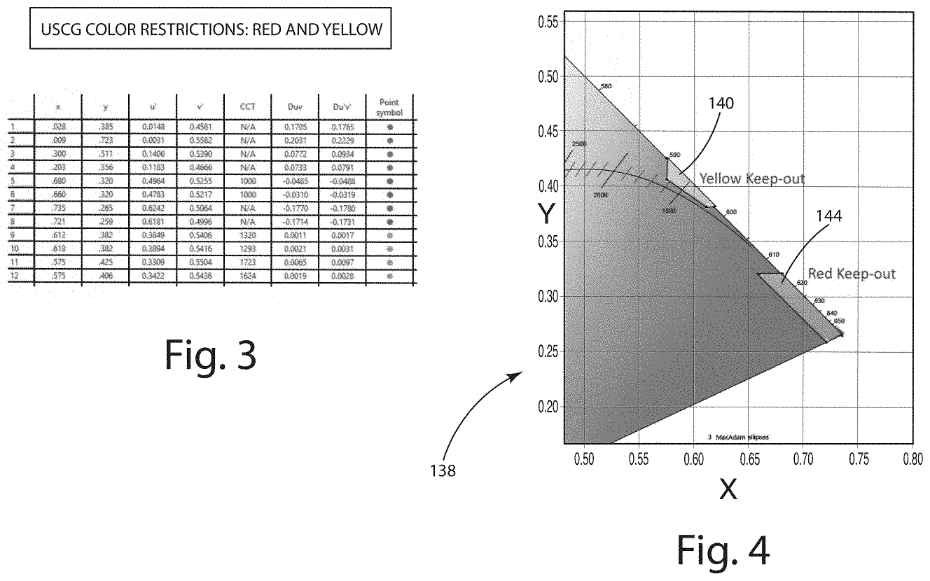

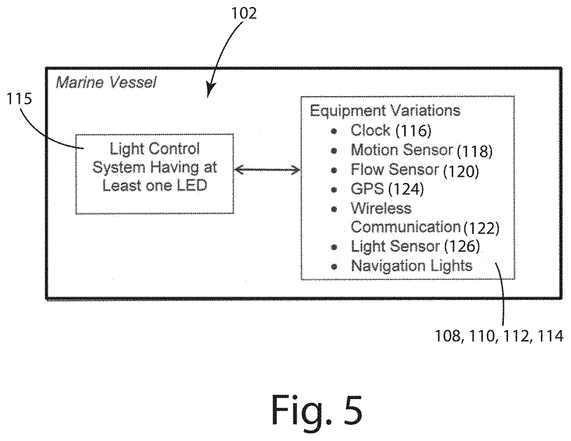

FIGS. 2-4 depict charts pinpointing the U.S. Coast Guard color restrictions. These color restrictions detail the specific spectrum of colors for which the U.S. Coast Guard prohibits illuminating from a marine vessel apart from the requisite navigation lights 110, 112, 114. If a marine vessel includes cabin or other lighting within the spectrum of colors for red, green and yellow as detailed in FIGS. 2 through 6, the vessel may be deemed out of compliance with regulation guidelines. FIG. 4 illustrates a chart 134 specifically illustrating the green color restrictions 136 as required by the U.S. Coast Guard. Light illuminating within the spectrum as illustrated at referenced numeral 136 is prohibited by U.S. Coast Guard regulations. The system of the present embodiment prohibits interior cabin or other lighting on a vessel from illuminating within the color spectrum as illustrated within the area as show by referenced numeral 136. Similarly, FIG. 5 illustrates the prohibited yellow 140 and red 144 color spectrums as illustrated in the graph 138. The color lock-out of the present system 100 prevents the color spectrum of vessel cabin lighting to illuminate within the spectrum of light as illustrated by reference numerals 140, 144.

FIG. 5 depicts a chart representation of the vessel 102 having a light control system 115. The light control system 115 may include at least one LED, commonly interior cabin lighting, and may be configured to receive one or more inputs and apply a logic to determine a color lock-out scheme. The color lock-out is enacted when a specific trigger is detected. The trigger may be tied to specific equipment variations, such as illustrated in FIGS. 1 and 7, including a clock, motion sensor, flow sensor, GPS, wireless communication system and/or an ambient light sensor. Other similar sensors may also be used and appreciated and incorporated into the present embodiments. It will be appreciated that the light control system 115, as described herein, may be an independent controller, or may be integrated with or in communication with other controllers, such as other vessel controllers. For example, the light control system 115 may be in communication with a controller, such as an engine controller, on the vessel 102 and may receive inputs, such as engine related inputs or other vessel inputs, through communication with the engine controller. The light control system 115 may further implemented in a plurality of controllers, such as a first controller to receive system inputs and a second controller to control system outputs and light spectrum lockout. The light control system 115 may alternatively comprise or incorporate a software or logic that is independent or integrated with other systems to receive the inputs descried herein, determine when a trigger condition is reached, and to lock out the predetermined light spectrum.

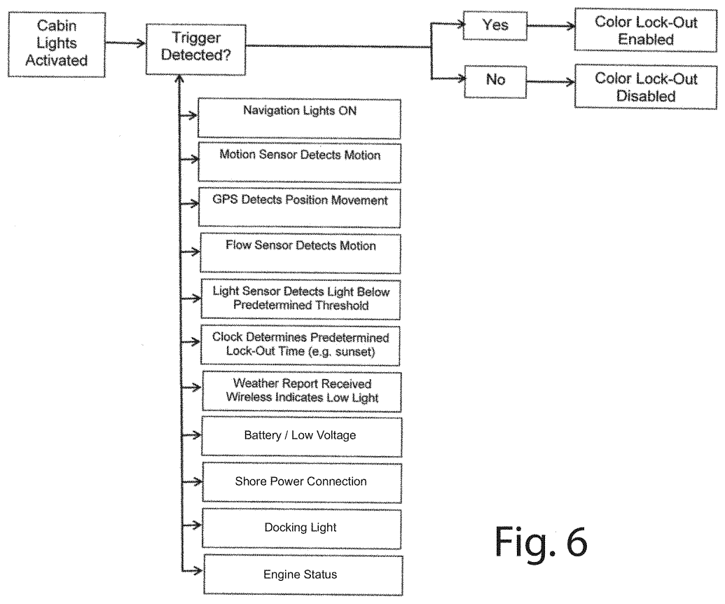

FIG. 6 illustrates a flowchart of the system of the present embodiment. If the cabin lights within the vessel are activated, a signal is sent to the light control system 115 to determine if a trigger has been detected or received. In the present embodiment, the trigger may include a plurality of different signals from sensors or gathering information wirelessly or based on other information received from the vessel 102. In some embodiments, the trigger is a determination that the vessel 102 is moving or in motion. For example, the trigger may be a determination that the navigation lights have been manually turned on. Other embodiments, the trigger may be a signal that the navigation lights have been turned on by activation of a secondary sensor. In other embodiments, the trigger may be a flow sensor to detect motion of the vessel 102. In other embodiments, the trigger is a detection of motion by a motion sensor determining that the vessel 102 is moving. In other embodiments, the trigger is a determination from a processor connected to the GPS system that detects that the vessel 102 is in motion or is stationary. In other embodiments, the trigger is a determination of the running condition of the engine. For example, the light control system 115 may receive an input to indicate that a vessel engine is running, in forward or reverse gear, or may receive a speed or RPM reading or feedback from the vessel engine.

In other embodiments, a clock connected to the vessel determines, based on a predetermined time that navigation lights are necessary or that the lock-out should be enabled. Furthermore, in other embodiments, weather reports or sunrise/sunset information is wirelessly communicated to the vessel thereby triggering the requirement for color lock-out. The light control system 115 may further be in communication with vessel systems to determine other appropriate triggers. For example, the trigger may comprise a detection of a low voltage or other battery condition. In other embodiments, the trigger may comprise notification of a vessel connection to shore power. In other embodiments, the trigger may comprise notification that docking lights on the vessel have been activated.

As illustrated by FIG. 6 if a trigger is not detected, then the color lock-out is disabled and the user is free to use any color within the standard color spectrum. If it is determined that a trigger has been detected, then the color lock-out is enabled thereby prohibiting a user to display colors prohibited by U.S. Coast Guard regulations, such as illustrated in FIGS. 4 and 6.

Appendix A illustrates additional graphical representations, chart representations, mathematical support, diagrams and discussion relating to the color lock-out system according to one or more embodiments shown and described herein.

The system as described herein may be used in connection with a computer or processor connected to an existing lighting system. Alternatively, the system may be installed as software into existing control systems on a computer and used in connection with the existing lighting on a vessel.

It should also be appreciated that the system of the present specification may be used in any marine vessel, not just in the example as shown and described herein. The system may also be used in any vehicle system such as automobiles, aircraft, recreational vehicles, motorcycles . . . etc. where lighting controls are utilized and local governments provide restrictions and regulations. Nothing in this disclosure shall serve to limit use of the present system only in connection with marine vessels.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

What is claimed is:

1. A marine vessel lighting system, comprising:
a light controller configured to control lighting parameters for one or more LED lights on a marine vessel, wherein the light controller is configured to modify the spectrum of light emitted from the one or more LED lights;
one or more inputs to the light controller, wherein the one or more inputs are configured to determine a condition for limiting the spectrum of light emitted from the one or more LED lights; and
wherein the light controller is configured to lock out the one or more LED lights from emitting a predetermined spectrum of light when an input indicating a condition for limiting the spectrum of light is received.

2. The marine vessel lighting system of claim 1, wherein the one or more inputs includes an input to determine the speed or movement of the vessel.

3. The marine vessel lighting system of claim 1, wherein the light controller is configured to lock out the predetermined spectrum of light from the one or more LEDs when the vessel is in motion.

4. The marine vessel lighting system of claim 2, wherein the input to determine the speed or movement of the vessel includes at least one of: a motion sensor to detect motion of the vessel; a flow sensor to detect the flow of water near the vessel; a GPS to detect movement of the vessel; an engine status input; and a light input indicating if a vessel navigation light is on.

5. The marine vessel lighting system of claim 4, wherein the engine status input includes notifying the light controller of at least one of: whether the engine is running; whether the engine is in forward or reverse gear; the speed of the engine; and the RPMs of the engine.

6. The marine vessel lighting system of claim 1, wherein the light controller is integrated with or in communication with a vehicle controller of the vessel.

7. The marine vessel lighting system of claim 1, wherein the light controller is configured to trigger lockout of the predetermined spectrum of light based on a time of day.

8. The marine vessel lighting system of claim 1, wherein the light controller is configured to receive a light sensor input, wherein the light sensor is configured to sense ambient light levels.

9. The marine vessel lighting system of claim 8, wherein the light controller is configured to trigger a lockout of the predetermined spectrum of light based on ambient light reaching a predetermined threshold.

10. The marine vessel lighting system of claim 1, wherein the spectrum of light to be locked out includes a spectrum of green light, a spectrum of red light, and a spectrum of white light, and a spectrum of blue light.

11. The marine vessel lighting system of claim 1, wherein the light controller is in communication with a controller on the vessel to receive inputs therefrom.

12. The marine vessel lighting system of claim 1, wherein the light controller comprises a software incorporated into a controller on the marine vessel.

13. The marine vessel lighting system of claim 1, wherein the one or more LED lights comprise cabin lights.

14. The marine vessel lighting system of claim 1, wherein the predetermined spectrum of light comprises a spectrum of light centered around the red, green, white or blue light color spectrums.
